(19) United States
(12) Patent Application Publication
(10) Pub. No.: US 2025/0179265 A1
(43) Pub. Date: Jun. 5, 2025

(54) ELASTOMERIC COMPOSITE MATERIALS

(71) Applicant: ARQ IP LIMITED, London (GB)

(72) Inventors: John Francis UNSWORTH, London (GB); Pranetr PATTABHIRAMAN, London (GB); Michael ROWLINSON, London (GB)

(21) Appl. No.: 18/847,123

(22) PCT Filed: Mar. 14, 2023
(86) PCT No.: PCT/EP2023/056524

§ 371 Date: Sep. 13, 2024

(30) Foreign Application Priority Data
Mar. 14, 2022 (GB) 2203532.3

(51) Int. Cl. C08K 3/04; B60C 1/00; C08K 7/00

(52) U.S. Cl. CPC C08K 3/04; B60C 1/00; C08K 7/00; C08K 2201/005; C08K 2201/014

(57) ABSTRACT

Elastomeric composite materials comprising at least one polymer component and purified carbonaceous product (PCP) composition are provided. The PCP is in particulate form, and at least about 90% by volume (% v) of the particles are no greater than about 25 μm in diameter and have an ash content of less than about 5 wt % as well as a water content of less than around 2 wt %. Articles of manufacture, such as vehicle tyres, are provided for. Processes for manufacturing the composite materials are described.

### FIELD OF THE INVENTION

The invention relates to compositions and methods for the manufacture of elastomeric materials utilised in tyres or other manufactured rubber goods (MRGs) that comprise a carbon-based additive material.

### BACKGROUND OF THE INVENTION

Elastomers are materials that are of synthetic or natural origin that have elastic properties, such that they regain their original shape once a load is removed. Often referred to as ‘rubber’, elastomeric materials are found in a diverse range of products from tyres, seals, gaskets, coatings, and drive belts, through to medical devices, furniture, building materials, garments, footwear and sporting goods.

Many elastomeric products contain significant concentrations of carbon-based additives, such as carbon black. These additives are included to improve a wide range of properties such as mechanical strength and wear resistance. Carbon black additives may contribute to material properties of an elastomeric product that include improvements in tensile strength, durability, abrasion resistance, hardness, elasticity and surface smoothness. These additives may also contribute towards ease of processing, thereby making the manufacturing process more efficient and improving overall quality control. In 2019, around thirteen million tonnes of carbon black was utilised globally.

Traditionally, carbon black is a particulate material produced by the incomplete combustion of heavy petroleum products such as fluid catalytic cracking tar, coal tar and ethylene cracking tar. However, there is a need to move away from petroleum derived products to improve sustainability. Hence, alternative sources of carbon black and related products are highly desirable. One solution has been to recycle carbon black from existing elastomeric products that have reached the end of their working lifetime. Uptake of so-called recovered carbon black (rCB) is hindered by significant costs of production and diverse substrate feedstock materials which contribute to concerns about the variability of quality in the rCB. Since the quality of the elastomeric end product is dependent, in part, upon the quality of rCB additive used there is an ongoing need to reduce variability in carbon black substitutes. Attempts to improve the quality of rCB have resulted in adoption of highly resource intensive processes such as pyrolysis of recycled materials, such as scrap rubber and discarded tyres.

Carbon black alternatives are also used that are comprised of virgin mined bituminous coal that is milled to an ultrafine particle size, for example Austin or Crown Black® 325

However, similarly to petroleum derived carbon black, this material is the product of active mineral extraction which leads to questions around its sustainability in the longer term. In addition, its derivation from native coal means that it contains high levels of inherent mineral content in the form of ash which can result in poorer performance in comparison to traditional carbon black elastomer additives.

The effect of coal structure and content on interfacial cohesion and mechanical strength of polymers has been reviewed (Eterigho-Ikelegbe, O., Yoro, K. O. & Bada, S., Resources, Conservation & Recycling 174 (2021) 105756, Coal as a Filler in Polymer Composites: A Review, and references therein). This describes improvements in flexural and tensile strength for polyethylene and polyvinyl alcohol from addition of coal particles below 125 micron and 44 microns in diameter.

US Patent Application No. 2021/0198467 A1 describes a rubber tyre inner liner that comprises an elastomer in the form of a halogenated butyl runner that includes mixture of carbon black and pulverized bituminous coal. The preferred coal derived additive is in the form of Austin Black® 325, a virgin mined coal as described above, and is blended as a minor component with the carbon black primarily for the purpose of enhancing air permeability resistance as well as improving fatigue resistance at low temperatures. Similar results for Austin Black® 325 are given in more recent publications (Sharp, E., Dearth, M., Foster, D. & Slovensky, J., Evaluation of sustainable bituminous coal in elastomer applications, Rubberworld 265 (6) 34-38, 22 Mar. 2022, and Kotadiya, H., Dutta, A., Satpathi, H., Bhandary, T., Das, S. K., Dasgupta, S. & Mukhopadhyay, R., Use of Coal Based Black in Tyre Inner Liner and Tube Compound: A New Sustainable End Use Application, Polymer Sci. peer Rev. J. 3 (5), PSpRJ.00574, 8 Jul. 2022).

European Patent No. 2196325 B1 describes rubber tyres in which the tread layer is designed to dissipate internally generated heat when run at high speed. The tread compound is comprised of a styrene-butadiene rubber (SBR) that comprises a mix of carbon black and pulverized virgin bituminous coal in the form of Austin Black® 325.

WO2017006937A1 describes the use of thermally conductive fillers derived from calcined petroleum coke, fired at a temperature between 700 to 2400° C., in rubber or resin compositions. The heat conductive filler can be made up of spherical non-graphitised particles, preferably, that have an average particle size of 0.01 to 100 μm.

Hence, there is a need to improve the availability of high-quality carbon black substitutes to meet high global demand. In addition, it is desirable to provide improved elastomeric composite materials. Furthermore, it would be advantageous to provide more sustainable sources of carbon black substitutes.

These and other uses, features and advantages of the invention should be apparent to those skilled in the art from the teachings provided herein.

### SUMMARY OF THE INVENTION

The invention relates to improvements in elastomeric materials and compositions that are comprised of composites of polymers with a filler material that is made of a purified carbonaceous composition. The elastomeric composites provided have improved properties including improved dispersibility of the filler within the polymer as well as superior tensile strength and toughness.

In a first aspect the invention provides elastomeric composite composition comprising at least one polymer component and purified carbonaceous product (PCP) composition, wherein the PCP is in particulate form, and wherein at least about 90% by volume (% v) of the particles are no greater than about 25 μm in diameter; and wherein the PCP has an ash content of less than about 5 wt % and a water content of less than around 2 wt %.

A second aspect of the invention provides for an article of manufacture that comprises an elastomeric composite composition as defined herein.

A third aspect of the invention provides a vehicle tyre comprised of an elastomeric composite material comprising at least one polymer component and a particulate component comprised of a purified carbonaceous product (PCP), wherein at least about 90% by volume (% v) of the particles have a planar morphology and are no greater than about 25 μm in diameter, as measured by laser diffraction; and wherein the PCP has an ash content of less than about 5 wt % and a water content of less than around 2 wt %.

In a third aspect the invention provides a process for the manufacture of an elastomeric composite material comprising (i) providing a purified carbonaceous product (PCP), wherein the PCP is in particulate form, and wherein at least about 90% by volume (% v) of the particles are no greater than about 25 μm in diameter, as measured by laser diffraction; wherein the PCP has an ash content of less than about 5 wt % and a water content of less than around 2 wt %; and (ii) combining the PCP with a polymer component to create an elastomeric composite material; wherein the elastomeric composite material comprises at least around 0.1 wt % and at most around 50 wt % PCP.

In a fourth aspect the invention provides a process for the manufacture of an elastomeric composite material comprising (i) providing a purified carbonaceous product (PCP), wherein the PCP is in particulate form, and wherein at least about 90% by volume (% v) of the particles are no greater than about 25 μm in diameter, as measured by laser diffraction; wherein the PCP has an ash content of less than about 5 wt % and a water content of less than around 2 wt %; and (ii) combining the PCP with a polymer component to create a composite material; wherein the elastomeric composite material comprises at least around 0.1 and at most around 100 parts per hundred of the PCP per unit of the polymer component (PHR).

In a fifth aspect the invention process for the manufacture of an elastomeric composite material comprising (i) providing a purified carbonaceous product (PCP), wherein the PCP is in particulate form, and wherein at least about 90% by volume (% v) of the particles are no greater than about 25 μm in diameter, as measured by laser diffraction; wherein the PCP has an ash content of less than about 5 wt % and a water content of less than around 2 wt %; (ii) combining the PCP with a carbon black material or a reclaimed carbon black (rCB) material to form a combined filler material; and (iii) combining the combined filler material with a polymer component to create a composite material; wherein the composite material comprises at least around 0.1 wt % and at most around 50 wt % PCP.

A sixth aspect of the invention provides a method for improving the surface smoothness of an elastomeric composite composition comprising at least one polymer component, the method comprising combining a purified carbonaceous product (PCP) with the at least one polymer component, wherein the PCP is in particulate form, and wherein at least about 90% by volume (% v) of the particles are no greater than about 25 μm in diameter, as measured by laser diffraction; wherein the PCP has an ash content of less than about 5 wt % and a water content of less than around 2 wt %.

A seventh aspect of the invention provides a use of a purified carbonaceous product (PCP) derived from coal waste as a filler for composite elastomeric materials that comprise an elastomeric polymer, wherein the PCP is in particulate form, and wherein at least about 90% by volume (% v) of the particles are no greater than about 25 μm in diameter, as measured by laser diffraction; wherein the PCP has an ash content of less than about 5 wt % and a water content of less than around 2 wt %.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 are scanning electron microscope (SEM) images that show dispersion results for three test styrene-butadiene elastomer compounds (a) an N660 carbon black reference; (b) a virgin bituminous commercial coal reinforcing filler (CCRF); and (c) PCP-A filler according to one embodiment of the invention.

FIG. 2 is a scanning electron microscope (SEM) image of a sample of PCP-A showing the planar plate-like morphology of the particles.

FIG. 3 shows a graph indicating the percentage change in properties after hot air ageing for exemplary formulations A-D and G.

FIG. 4 shows a graph indicating the percentage change in properties after hot air ageing for exemplary formulations S-V.

### DETAILED DESCRIPTION OF THE INVENTION

All references cited herein are incorporated by reference in their entirety. Unless otherwise defined, all technical and scientific terms used herein have the same meaning as commonly understood by one of ordinary skill in the art to which this invention belongs.

Prior to setting forth the invention in greater detail, a number of definitions are provided that will assist in the understanding of the invention.

As used herein, the term “comprising” means any of the recited elements are necessarily included and other elements may optionally be included as well. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

The term “coal” is used herein to denote readily combustible sedimentary mineral-derived solid hydrocarbonaceous material including, but not limited to, hard coal, such as anthracite; bituminous coal; sub-bituminous coal; and brown coal including lignite (as defined in ISO 11760:2005). “Native” or “feedstock” coal refers coal that has not been subjected to extensive processing and comprises a physical composition (e.g. maceral content) that is substantially unchanged from the point of extraction.

As used herein, the term “ash” refers to the inorganic—e.g. non-hydrocarbon—mineral component found within most types of fossil fuel, especially that found in coal. Ash is comprised within the solid residue that remains following combustion of coal, sometimes referred to as fly ash. As the source and type of coal is highly variable, so is the composition and chemistry of the ash. However, typical ash content includes several oxides, such as silicon dioxide, calcium oxide, iron (III) oxide and aluminium oxide. Depending on its source, coal may further include in trace amounts one or more substances that may be comprised within the subsequent ash, such as arsenic, beryllium, boron, cadmium, chromium, cobalt, lead, manganese, mercury, molybdenum, selenium, strontium, thallium, and vanadium.

The term “purified carbonaceous product” or “PCP” as used herein refers to a material that is comprised of a carbon-containing, hydrocarbonaceous or carbonaceous, substance of geological or biological origin—e.g. coal, coke, pet coke, and/or biochar. A PCP is typically subjected to various process steps to reduce non-carbonaceous substances that are present, such as ash or sulfur, to a minimum. Purified coal compositions are different to coals in their native or un-purified state. Likewise, carbonaceous substances may be purified from starting feedstocks of coke, pet coke, or biochar that are subjected to processes to deplete non-carbonaceous content, such as ash, sulfur, and/or water. Typically, the PCP of geological or biological origin according to embodiments of the present invention will comprise an ash content of less than 5 wt %, suitably less than 4 wt %, optionally less than 3 wt %, in certain cases less than 2 wt %, and in specific embodiments no more than 1 wt %. Conventional non-purified virgin coal-based carbon black substitutes (such as Austin Black® 325) have an ash content of around 7.5 wt % or more, as well as a different particulate morphology and porosity.

As used herein the term “low ash coal” refers to native coal that has a proportion of ash-forming components that is lower when compared to other industry standard coals. Typically, a low ash native or feedstock coal will comprise less than around 12 wt % ash. The term “deashed coal”, or the related term “demineralised coal”, is used herein to refer to coal that has a reduced proportion of inorganic minerals compared to its natural native state. Ash content may be determined by proximate analysis of a coal composition as described in ASTM D3174-12 Standard Test Method for Ash in the Analysis Sample of Coal and Coke from Coal.

Inferior coal is a term used in geological survey of the quality of coal seams (e.g. UK coal survey, 1937) and refers to intrinsic ash in coal bands or coal seams above 15.1 wt % and below 40.0 wt %. Coal bands or coal seams consisting of inferior coal contain mineral matter intimately mixed within the coal itself and consequently are very difficult to purify using conventional coal processing techniques. The methods described in embodiments of the invention allow for the use of inferior coal, particularly waste or spoil that comprises inferior coal, to be utilised as a feedstock for the production of carbon black substitutes.

As used herein, the term “coal fines” refers to coal in particulate form with a maximum particle size typically less than 1.0 mm. The term “coal ultrafines” or “ultrafine coal” or “ultrafines” refers to coal with a maximum particle size typically less than 0.5 mm (500 microns (μm), approximately 0.02 inches). The term “coal microfines” or “microfine coal” or “microfines” refers to coal with a maximum particle size typically less than 20 μm.

Most suitably the particle size of the coal fines that is utilized as feedstock may be at most 1000 μm or 500 μm. Specifically, the maximum average particle size may be at most 500 μm. More suitably, the maximum average particle size may be at most 300 μm, 250 μm, 200 μm, 150 μm, or 100 μm. Most suitably, the maximum average particle size may be at most 75 μm, 50 μm, 40 μm, 30 μm, 20 μm, 10 μm, or 5 μm. The minimum average particle size may be 0.01 μm, 0.1 μm, 0.5 μm, 1 μm, 2 μm, or 5 μm. Hence, in particular embodiments the invention includes utilisation of nanoscale coal fines with average particle sizes in the sub-micron range.

An alternative measure of particle size is to quote a maximum particle size and a percentage value or “d” value for the proportion by volume of particles within the sample or composition that fall below that particle size. For the present invention, any particle size of PCP that is suitable for use as an additive for blending with an elastomeric polymer material is considered to be encompassed by the invention. Suitably, the particle size of the PCP is in the ultrafine range. Most suitably the particle size of the PCP is in the microfine range. Specifically, the maximum particle size may be at most 500 μm. More suitably, the maximum particle size may be at most 300 μm, 250 μm, 200 μm, 150 μm, or 100 μm. Most suitably, the maximum particle size may be at most 75 μm, 50 μm, 40 μm, 30 μm, 25 μm, 20 μm, 15 μm, 10 μm, or 5 μm. The minimum particle size may be 0.01 μm, 0.1 μm, 0.5 μm, 1 μm, 2 μm, or 5 μm. Any “d” value may be associated with any one of these particle sizes. Suitably, the “d” value associated with any of the above maximum particle sizes may be d99, d98, d95, d90, d80, d70, d60, or d50. A d value may also, or additionally, represent a mass division diameter; the diameter which, when all particles in a sample or composition are arranged in order of ascending mass, thereby dividing the mass into specified percentages. The percentage mass of a composition below the diameter of interest is the number expressed after the “d”. Hence, a d90 of 10 μm can indicate that 90 percent of the mass of the composition is comprised within particles of less than 10 μm in diameter. To maximize the chemical and physical interaction of micronized PCP with the base elastomeric polymer it is desirable for the particle size to be both relatively homogeneous and small, in order to enable the small particles to be well-dispersed in the polymer phase. For instance, in a specific embodiment of the invention the PCP has a d90 or higher of <100 μm, <90 μm, <70 μm, <50 μm, <25 μm, optionally <20 μm, suitably <10 μm. In some embodiments of the invention, the PCP has a d99 of <70 μm, <60 μm, <50 μm, <40 μm, <25 μm, optionally <20 μm, suitably <10 μm.

Particle size can be characterized by a number of different techniques (laser diffraction, dynamic light scattering, electrophoretic light scattering, automated imaging, sedimentation, etc.) which do not always correspond exactly. In a specific embodiment of the invention, laser diffraction techniques are employed to measure particle size distributions and to specify particle size parameters.

In embodiments of the present invention the particles of the PCP have a planar, flattened or plate/disc-like morphology. In such embodiments, the reference to a maximum or average particle size as mentioned above refers to the maximum diameter of the particle, that is the diameter of the planar surface of the PCP particle.

As used herein, the term “water content” refers to the total amount of water within a sample of PCP and is expressed as a concentration or as a mass or weight percentage (% m or wt %). When the term refers to the water content in a coal sample it includes the inherent or residual water content of the coal, and any water or moisture that has been absorbed from the environment. As used herein the term “dewatered coal” refers to coal that has an absolute proportion of water that is lower than that of its natural state. The term “dewatered coal” may also be used to refer to coal that has a low, naturally occurring proportion of water. Water content may be determined by analysis of a native or purified coal composition as described in ASTM D3302/D3302M-17 Standard Test Method for Total Moisture in Coal. Water content may also apply to the inherent level of moisture present in products comprised of PCP, such as pellets or granules that comprise PCP as a minority or majority constituent.

The present invention provides for elastomeric composite compositions comprising at least one polymer component and purified carbonaceous product (PCP) composition as defined herein. The PCP performs as an additive and filler and may replace all or a part of the typical carbon black component of the composite composition. Elastomeric polymer composites may also comprise a polymer and an organic (e.g. cellulose) or inorganic filler (e.g. calcium carbonate—e.g. chalk—or silica), or combination of fillers or which the PCP represents a portion thereof. In addition, the elastomeric polymer composites may also include further components depending on the intended application of the composite as would be a matter of routine to a worker skilled in the field. Further components may include, plasticizers, tackifying agents, curing agents, pigments, void or pore forming agents, reinforcing fillers, stabilizers, bulking agents, processing aids, antioxidants and such like.

The elastomeric composite will comprise one or more polymers, e.g. the elastomer component. The polymers selected may comprise natural or synthetic polymers that are typically described as rubbers. The polymer can be used in conventional amounts in combination with the PCP containing additive filler. It is an advantage of the invention that the PCP additive may be used as a drop-in substitute for conventional carbon black compositions, requiring little or no modification of current handling or manufacturing processes. The composite may also comprise one or more coupling agents to facilitate coupling of the PCP filler to the elastomeric polymer. Suitable coupling agents used in compounding are known to the skilled person, but may include those of the silane, zirconate or titanate type.

The compounding amount of the PCP may be at least 5, 10, 20, 30, 40, 50, 60, 80, 90 or up to 100 parts by weight, typically at least 30, and at most up to 80 parts by weight with respect to 100 parts by weight of the elastomeric polymer component (i.e. parts per hundred, or ‘PHR’).

The PCP may be used as a partial carbon black replacement and embodiments of the invention the PCP may replace at least 1, 5, 10, 20, 30, 40, 50, 60, 70, 80 or up to 90% wt of a native or recovered carbon black within an elastomeric polymer composition.

Suitable elastomeric polymers may be compounded with the PCP to provide the elastomeric composite material. Exemplary elastomers include, but are not limited to, homo- or co-polymers of 1,3 butadiene (e.g. butyl rubbers), styrene, isoprene, isobutylene, 2,3-dimethyl-1,3-butadiene, acrylonitrile, ethylene, and propylene. Further examples include, but are not limited, acrylonitrile butadiene rubber (NBR), ethylene propylene diamine monomer rubber (EPDM), bromobutyl rubber, styrene-butadiene rubber (SBR), natural rubber (e.g. latex, natural isoprene polymer, caucho and India rubber), halogenated rubbers (such as chloro butyl and bromo butyl rubber), silicone, phosphazene, thionylphosphazene, fluoropolymers, polyolefins, polyesters, nylon, polyamides, polybutadiene, polyisoprene, and their oil-extended derivatives. Blends of any of the foregoing can also be used.

Particular embodiments of the invention provide for elastomeric compositions that comprise PCP for use in barrier applications. The improved dispersion characteristics of PCP when compared to alternative products, such as conventional virgin CCRF or rCB, provides for production of elastomeric products with superior surface characteristics. For example, the elastomers or embodiments of the invention are suited to use in the manufacture of tyre liners, diaphragms, gaskets, hoses as well as barrier membranes, films, and sheets. In one specific embodiment, there is provided a pneumatic tyre sub-tread component, such as a tyre liner, that comprises an elastomer including an amount of PCP as a filler.

Conventional compounding techniques known to those skilled in the art can be used to prepare the elastomer composites described herein and to incorporate the PCP as a substitute for conventional carbon black. The mixing of the rubber or polymer compound can be accomplished by methods known to those having skill in the rubber mixing art.

The elastomeric compositions may be used in standard final form or compounded as masterbatch formulation as is understood by those skilled in the art.

Elastomeric or rubber composites produced according to the present invention are useful in articles of manufacture, including, vehicle tyres (including tyre linings and inner tubes), seals, gaskets, drive belts, conveyor belts, rubber mats, rubber or polymer based hose, flooring, dampeners, shock absorbers, rubber membranes for use in construction, rubberised coatings, elastomeric polymer textiles, elastic (e.g. bungee cord), protective equipment (e.g. footwear, aprons, PPE etc.), medical devices (e.g. prosthesis liners and other components), as well as sporting equipment and apparel.

In specific embodiments of the present invention the elastomeric composite materials comprising PCP are suitable for use in manufacture of carcass components of automotive tyres. The improved dispersion properties of the PCP within polymers such as styrene-butadiene rubber, are particularly advantageous for sub-tread components including tyre lining layers and cushion layers that are comprised within the multilaminate structure of a tyre.

Demineralising and dewatering of coal fines, suitably from waste or discard sources, to produce a PCP may be achieved via a combination of froth flotation separation, specifically designed for ultrafines and microfine particles, plus mechanical and thermal dewatering techniques. Typically, PCP may be produced from a feedstock of particulate coal via processes that comprise particle size reduction, mineral matter removal, dewatering and drying. Some or all of these steps may be altered or modified to suit the specification of the starting material or of the desired end product. The key process steps are summarised below in relation to a typical starting material derived from an impoundment, tailings pond or production tailings underflow.

### Particle Size Reduction

The starting material is reduced to a particle size of d80=30-50 microns (or finer in some coals) to achieve efficient separation to a target mineral matter (ash) content of 5-8 wt %. To achieve this, a feed comprising the starting material is diluted with water to achieve a solids content of in the range 20-40 wt %, then ground in a ball or bead mill depending on the top size of the feedstock. The product is screened at a size range of approximately 100 microns to exclude particles above this size. A dispersant additive may be included to optimise energy use during size reduction (e.g. lignin-based dispersants, such as Borresperse, Ultrazine and Vanisperse manufactured by Borregaard, 1701 Sarpsborg, Norway). Suitable equipment for size reduction is manufactured by Metso Corporation, Fabianinkatu 9 A, PO Box 1220, FI-00130 Helsinki, FIN-00101, Finland; Glencore Technology Pty. Ltd., Level 10, 160 Ann St, Brisbane QLD 4000, Australia, and FLSmidth, Vigerslev Alle 77, 2500 Valby, Denmark.

### Ash Removal

One or a series of froth flotation stages are carried out to bring the entrained mineral content down to the target level. For some coals where the mineral matter is disseminated mainly within sub-10-micron size domains, more than one stage of flotation following further milling may be required to achieve a low ash level.

During froth flotation a coal slurry is diluted further with water typically to a range of 5-20 wt % solids then collected in a tank and froth flotation agents, known as frother (e.g. methyl iso-butyl carbinol and pine oil) and collector (e.g. diesel fuel or other hydrocarbon oil, and Nasmin AP7 from Nasaco International Co., Petite Rue 3, 1304 Cossonay, Switzerland), are added using controlled dose rates. Micro particle separators (e.g. Flotation test machines manufactured by Eriez Manufacturing Co., 2200 Asbury Road, Erie, Pa. 16505, USA, by FLSmidth, Vigerslev Alle 77, 2500 Valby, Denmark, by Metso Corporation, Fabianinkatu 9 A, PO Box 1220, FI-00130 Helsinki, Finland, and GTEK Mineral Technologies Co. Ltd.) filled with process water and filtered air from an enclosed air compressor are used to sort hydrophobic carbon materials from hydrophilic mineral materials. Froth containing hydro-carbonaceous particles overflows the tank and this froth is collected in an open, top gutter. The mineral pulp is retained in the separation tank until discharged, whereas the demineralised coal slurry is de-aerated, before being subjected to additional processing.

### Dewatering

The concentrate from froth flotation is dewatered with a filter-press or tube-press to a target range of 20-50 wt % depending on the actual particle size, under pressure or vacuum, sometimes with air-blowing, to remove water by mechanical means, in order to generate feed for the extruder. Suitable filter-press equipment is manufactured by Metso, FI-00130 Helsinki, Finland, FLSmidth, Valby, Denmark, and by Outotec. Rauhalanpuisto 9, 02230 Espoo, Finland.

In some instances, flocculant (or thickener, e.g. anionic polyacrylamide additive manufactured by Nalco Champion, 1 Ecolab Place, St. Paul, MN 55102-2233, USA) is added to optimise settling properties and underflow density. To optimise the procedure settling tests are carried out to measure settling rates and generate a settling curve, tracking underflow density with time.

Filtration may also be necessary depending on the filtration rate and resultant cake moisture. To optimise the procedure feed % solids (thickened/un-thickened), feed viscosity, pH and filtration pressure will be measured, Filter cloths are chosen after assessment of cake discharge and blinding performance. Suitable filter cloths are manufactured by Clear Edge Filtration, 11607 E 43rd Street North, Tulsa, Oklahoma 74116 USA.

In some circumstances a Decanter Centrifuge can be incorporated into the process design to concentrate the solids content prior to the filter press. Suitable equipment is manufactured by Alfa Laval Corporate AB, Rudeboksvägen 1, SE-226 55 Lund, Sweden.

### Drying

The PCP product may be dried thermally to reduce water to below 5 wt %, suitably below 2 wt % and in specific embodiments less than 1 wt %. This may be achieved directly on the PCP, or by pelleting or granulating it first to facilitate handling, by conveying it to a belt dryer where oxygen-deprived hot process air is blown directly over the microfine coal. Suitable equipment is manufactured by STELA Laxhuber GmbH, Öttingerstr. 2, D-84323 Massing, Germany or by GEA Group Aktiengesellschaft, Peter-Müller-Str. 12, 40468 Dusseldorf, Germany; drying in a ring drier in a reduced oxygen or inert environment may be carried out in driers made by Dedert (17740 Hoffman Way, Homewood, Illinois 60430, USA), GEA (Peter-Müller-Str. 12, 40468 Düsseldorf, Germany), or Swedish Exergy (Gamla Rambergsvägen 34 SE-417 10, Gothenburg, Sweden); drying in a rotary drier system, indirectly heated with natural gas burners on a shroud in contact with the inner shell, such as those made by Mitchell Dryers (Mitchell Dryers (Kingmoor) Ltd, Unit B, Kings Drive, Kingmoor Park South, Carlisle CA6 4RD, UK) or the helical screw-type rotary drier, with hollow flights that use oil or steam as thermal fluids, such as those made by Komline-Sanderson (Komline-Sanderson, 12 Holland Avenue, PO Box 257, Peapack, NJ 07977 USA).

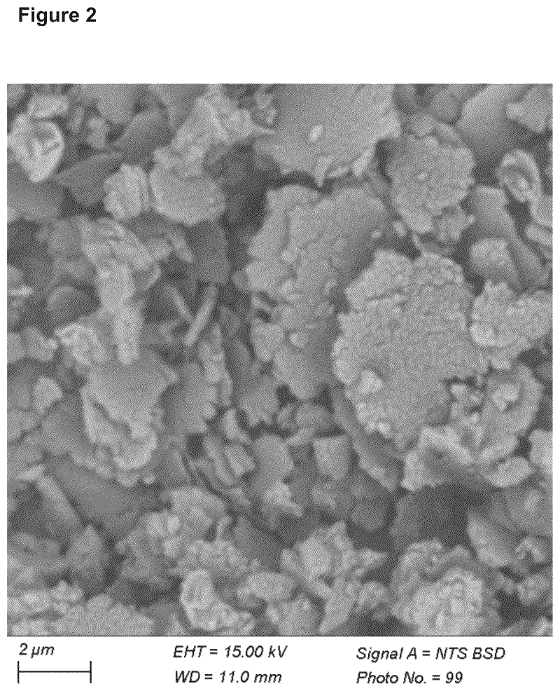

In specific embodiments, the PCP is characterised has having particles that adopt a flattened disc or plate-shaped morphology. This unique morphology is shown in FIG. 2 and is distinct from conventional particles of virgin coal which tend to be more irregular agglomerates having a substantially globular morphology. Without wishing to be bound by theory, it is believed that the improved dispersion characteristics may be due, at least in part, to the flattened disc-shaped morphology of the PCP particles. In addition, the confined particle size distribution described previously may act synergistically with the morphology to confer quite distinct properties when used as an additive in elastomeric materials.

The invention is further illustrated by the following non-limiting examples.

### EXAMPLES

### Example 1—Comparison of PCP to N660 Carbon Black

The colloidal properties of two PCP samples prepared from a bituminous coal (Eastern Kentucky, USA) and five carbon blacks using standard ASTM carbon black tests (such as ASTM D1765, D6556, and D2414) are presented in Table 1 below.

TABLE 1
Properties of PCPs and Carbon blacks

| | | | | Carbon blacks | | | | |
|---|---|---|---|---|---|---|---|---|
| Test | Units | PCP-A | PCP-B | N660 | N772 | N550 | N650 | N762 |
| NSA | m²/g | 24.2 | 6.4 | 35 | 32 | 40 | 36 | 29 |
| STSA | m²/g | 17.8 | 5.8 | 34 | 30 | 39 | 35 | 28 |
| OAN | mL/100 g | 95.3 | 76.6 | 90 | 65 | 121 | 122 | 65 |
| Ash content | % m | 1.0 | 2.5 | Not available | | | | |
| Average | microns | 3.0 | 7.5 | | | | | |
| particle size | | | | | | | | |
| d90 | microns | 6.1 | 10.7 | | | | | |
| d95 | microns | 7.7 | 16.3 | | | | | |

PCP-A has a lower external surface area (STSA) with a higher total surface area (NSA) which is indicative of a material having a degree of porosity. Structure as measured by the oil absorption number (OAN) is used to determine a filler's potential to occlude polymer which raises a rubber compound's stiffness under imposed strain. The PCP-A is similar to the N660 carbon black comparator in relation to OAN. PCP-B has lower NSA, STSA and OAN than either PCP-A or N660.

PCP-A has been milled to a smaller average particle size than PCP-B; 3.0 microns for PCP-A compared with 7.5 microns for PCP-B. Similarly PCP-A has lower d90 and d98 values than PCP-B.

The surface activity of the PCP material is also fundamental to its elastomer compound performance, this property is harder to assess with a convenient analytical test. A good approach is, therefore, to mix and assess performance in a rubber compound. In-rubber testing provides additional understanding of dispersion, cure and reinforcing characteristics which are inter-related.

The carbon blacks tested were chosen because of their compatibility with the particular rubber elastomers, i.e. N660 with SBR and BIIR, N762 with NR, N550 with NR, N550 and N762 with NBR and N650 with EPDM.

### Example 2—In-Elastomer Testing of PCP-A Performance

PCP-A was mixed into a standard styrene-butadiene rubber (SBR) compound (SBR 1502) together with conventional additives (TDAE oil, zinc oxide, stearic acid, 6PPD, TBBS and sulphur) and was compared to N660 carbon black and a virgin CCRF sample at equal loading.

Sections of compound were prepared using fresh razor blades and imaged using optical microscopy at ×5 magnification under dark field lighting. Surface roughness maps (×250 magnification) were also generated using a Hitachi TM3030 SEM fitted with an annular multi-segmented back-scattered electron detector.

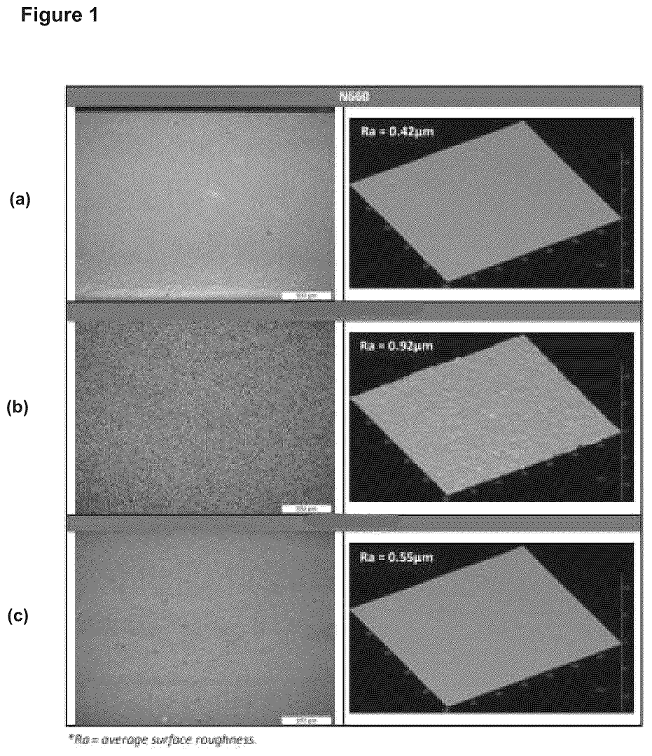

FIG. 1 shows SEM dispersion results for the three test SBR compounds. PCP-A was found to disperse efficiently within the SBR producing an average surface roughness of 0.55 microns (see FIG. 1 (c)). This is close to the surface roughness of N660 SBR of 0.42 microns (FIG. 1 (a)). The PCP-A had superior dispersion characteristics versus the CCRF sample which produced an average surface roughness of 0.92 microns (FIG. 1 (b)).

Table 2 presents a summary of the cure characteristics (rheometry) and physical properties of the three test SBR compounds. The PCP had better reinforcing potential versus the CCRF sample, this being indicated by higher high strain modulus and improved tensile strength.

TABLE 2
Cure characteristics and physical properties
of SBR compounds containing 60 phr carbon
black N660, 60 phr CCRF and 60 phr PCP-A

| Test | Unit | N660 | CCRF | PCP-A |
|---|---|---|---|---|
| Min torque | dNm | 1.54 | 1.55 | 1.77 |
| Max torque | dNm | 16.67 | 14.98 | 10.29 |
| Ts2 | min | 5.03 | 6.38 | 6.97 |
| T90 | min | 11.72 | 14.61 | 28.60 |
| Density | g/cm³ | 1.159 | 1.074 | 1.106 |
| Shore A | º | 29 | 55 | 52 |
| (ASTM D2240) | | | | |
| M100% | MPa | 2.44 | 1.71 | 1.63 |
| M300% | MPa | 10.6 | 3.39 | 4.77 |
| Tensile Strength | MPa | 16.0 | 4.9 | 7.5 |
| Elongation at | % | 441 | 577 | 617 |
| break | | | | |

The above findings indicate that the PCP-A material disperses efficiently and provides surprising higher reinforcing potential versus the CCRF product, albeit less than the N660.

Based on these results the PCP-A shows particular suitability when used in SBR for moulded rubber goods and barrier applications (e.g. roofing, barrier membranes, tyre liners and sub-tread component layers, seals/gaskets). The superior dispersion of PCP-A material versus the CCRF may also allow higher loading in blends and extended use in products requiring a better or finer surface appearance and texture.

### Example 3—Influences of Elastomer Composite Filler Loading for Styrene Butadiene Rubber Blends Using the PCP-A in Comparison to Either N660, a Commercial CCRF or PCP-B

### Materials and Methods:

Compounding: A generic SBR formulation was used to evaluate the in-rubber performance of the filler samples, as detailed in Table 3. Compounds were produced using a HAAKE Rheomix OS/610 of 78 cm³ chamber volume with Banbury style rotors set at 40° C. and 60 rpm, following the procedure outlined in Table 4. A fill factor of 70% was used.

Moving Die Rheometer (MDR): Used to assess the cure characteristics of the compounds and to allow preparation of cured sheets using a cure time of t90+5 minutes. Testing was conducted at 160° C. for 30 mins, following ASTM D5289.

Cure Conditions: 150×150×2 mm sheets were cured at 160° C. for a period of t90+5 minutes.

Hardness: Shore A hardness was tested to ASTM D2240.

Tensile Properties: Were determined following ASTM D412.

### Formulations:

A 60 phr PCP-A+0.5 DPG+2 PEG4000
B 70 phr PCP-A+0.5 DPG+2 PEG4000
C 80 phr PCP-A+0.5 DPG+2 PEG4000
D 35 phr PCP-A, 30 phr N660+0.25 DPG+1 PEG4000
E 30 phr PCP-A, 30 phr Coal+0.25 DPG+1 PEG4000
F 60 phr Commercial rCB
G 60 phr N660
H 60 phr Commercial CCRF
I 60 phr PCP-B+0.5 DPG+2 PEG4000

TABLE 3
Formulation details for SBR compounds

| | | | | | | | | | |
|---|---|---|---|---|---|---|---|---|---|
| Ingredient | A | B | C | D | E | F | G | H | I |

Concentration in parts per hundred rubber (phr)

| | | | | | | | | | |
|---|---|---|---|---|---|---|---|---|---|
| SBR 1502 (Intol 1502) | 100 | 100 | 100 | 100 | 100 | 100 | 100 | 100 | 100 |
| PCP-A Filler | 60 | 70 | 80 | 35 | 30 | — | — | — | — |
| PCP-B Filler | — | — | — | — | — | — | — | — | 60 |
| N660 | — | — | — | 30 | — | — | 60 | — | — |
| CCRF | — | — | — | — | 30 | — | — | 60 | — |
| rCB | — | — | — | — | — | 60 | — | — | — |
| TDAE Oil (Vivatec 500) | 10 | 10 | 10 | 10 | 10 | 10 | 10 | 10 | 10 |
| Zinc Oxide | 5 | 5 | 5 | 5 | 5 | 5 | 5 | 5 | 5 |
| Stearic Acid | 2 | 2 | 2 | 2 | 2 | 2 | 2 | 2 | 2 |
| 6PPD | 1.5 | 1.5 | 1.5 | 1.5 | 1.5 | 1.5 | 1.5 | 1.5 | 1.5 |
| PEG4000 | 2 | 2 | 2 | 1 | 1 | — | — | — | 2 |
| DPG | 0.5 | 0.5 | 0.5 | 0.25 | 0.25 | — | — | — | 0.5 |
| TBBS | 1.5 | 1.5 | 1.5 | 1.5 | 1.5 | 1.5 | 1.5 | 1.5 | 1.5 |
| Sulphur | 1.5 | 1.5 | 1.5 | 1.5 | 1.5 | 1.5 | 1.5 | 1.5 | 1.5 |

TABLE 4
Mixing procedures for SBR, NR and BIIR examples

| SBR (Example 3), | | | | | | | |
|---|---|---|---|---|---|---|---|
| NR (Example 5) | | NBR (Example 5) | | EPDM (Example 5) | | BIIR (Example 6) | |
| Time | | Time | | Time | | Time | |
| (mins) | Step | (mins) | Step | (mins) | Step | (mins) | Step |

Masterbatch cycle

| | | | | | | | |
|---|---|---|---|---|---|---|---|
| / | Add polymer | / | Add polymer | / | Add polymer | / | Add polymer |
| 0 | Ram Down | 0 | Ram down | 0 | Ram down | 0 | Ram Down |
| 0.5 | *Powders/Oil | 0.5 | Add half filler + | 0.5 | Add half filler | 0.5 | *Powders/Oil |
| | | | oil + additives | | | | |
| 1 | Ram Down | 1 | Ram down | 1 | Ram down | 1 | Ram Down |
| 3 | Ram Bump | 2 | Add half filler | 2 | Add half filler + | 2 | Ram Bump |
| | | | and Ram down | | oil + additives | | |
| | | | | | and Ram down | | |
| 5 | Dump | 5 | Dump | 6 | Dump | 4 | Add Curing |
| | | | | | | | additives |
| | | | | | | 5.5 | Dump |

Conversion cycle

| / | Add | 1 | Add | — | Add | Covered in |
|---|---|---|---|---|---|---|
| | Masterbatch | | Masterbatch | | Masterbatch | Masterbatch cycle |
| 0 | Ram Down | 0 | Ram Down | 0 | Ram down | |
| 0.33 | Add Curatives | 0.33 | Add Curatives | 0.33 | Add curatives | |
| 0.5 | Ram Down | 0.5 | Ram Down | 0.5 | Ram down | |
| 2 | Dump | 2 | Dump | 2 | Dump | |

### Results:

Following compounding, the dispersion level achieved in the elastomer with each of the filler samples was assessed using SEM as previously described. Dispersion of the PCP-A filler was approaching that of N660 and was significantly better compared to the reference CCRF (H). No significant impact was identified when increasing the PCP-A filler loading or blending it with N660 (D). Based on the average surface roughness values, dispersion of the PCP-A appears similar to the rCB sample (F).

Dispersion of PCP-B in formulation I was also better than CCRF giving an average surface roughness (Ra) of 0.60 microns, compared with 0.55 microns and 0.92 microns for formulations A and H respectively.

Rheology properties are summarised in Table 5 for the formulations A-I.

TABLE 5
Cure characteristics and physical properties of SBR compounds

| | | | | | | | | | | |
|---|---|---|---|---|---|---|---|---|---|---|
| | | | | A | B | C | D | E | | I |
| | | G | H | PCP-A | PCP-A | PCP-A | PCP-A/ | PCP-A/ | F | PCP-B |
| Test | Unit | N660 | CCRF | 60 phr | 70 phr | 80 phr | N660 | Coal | rCB | 60 phr |

MDR @ 160° C.

| | | | | | | | | | | |
|---|---|---|---|---|---|---|---|---|---|---|
| Min Torque | dNm | 1.54 | 1.55 | 1.63 | 2.24 | 2.33 | 1.92 | 1.56 | 1.97 | 1.38 |
| Max Torque | dNm | 16.67 | 14.98 | 10.41 | 11.46 | 11.71 | 13.23 | 12.78 | 15.05 | 14.20 |
| Ts2 | min | 5.03 | 6.38 | 4.83 | 5.59 | 5.39 | 4.23 | 4.83 | 4.35 | 2.93 |
| T90 | min | 11.72 | 14.61 | 18.98 | 26.25 | 26.17 | 14.36 | 15.59 | 9.96 | 7.47 |

Physical Properties

| | | | | | | | | | | |
|---|---|---|---|---|---|---|---|---|---|---|
| Density | g/cm3 | 1.159 | 1.074 | 1.066 | 1.080 | 1.084 | 1.118 | 1.072 | 1.162 | n.a. |
| Shore A | ° | 59 | 55 | 56 | 58 | 60 | 60 | 55 | 61 | 56 |
| M100% | MPa | 2.44 | 1.71 | 1.67 | 1.99 | 2.07 | 2.11 | 1.54 | 2.13 | 2.04 |
| M300% | MPa | 10.6 | 3.39 | 4.51 | 5.10 | 5.06 | 6.63 | 3.69 | 7.80 | 3.81 |
| Tensile | MPa | 16.0 | 4.9 | 7.5 | 6.6 | 6.3 | 12.1 | 8.9 | 17.8 | 6.4 |
| Strength | | | | | | | | | | |
| Elong. @ | % | 441 | 577 | 728 | 512 | 499 | 737 | 944 | 616 | 640 |
| Break | | | | | | | | | | |

Aged Physical Properties (7 days @ 70° C.)

| | | | | | | | | | | |
|---|---|---|---|---|---|---|---|---|---|---|
| Shore A | ° | 66 | 60 | 62 | 65 | 66 | 66 | 60 | 66 | n.a. |
| M100% | MPa | 3.85 | 2.17 | 2.53 | 2.99 | 3.13 | 3.19 | 2.27 | 3.18 | n.a. |
| M300% | MPa | 14.70 | 3.81 | 6.79 | 7.50 | 7.47 | 9.11 | 4.82 | 10.90 | n.a. |
| Tensile | MPa | 18.3 | 6.4 | 8.8 | 8.5 | 8.5 | 12.4 | 7.8 | 17.0 | n.a. |
| Strength | | | | | | | | | | |
| Elong. @ | % | 397 | 598 | 564 | 465 | 465 | 529 | 63 | 455 | n.a. |
| Break | | | | | | | | | | |

Dynamic Properties

| | | | | | | | | | | |
|---|---|---|---|---|---|---|---|---|---|---|
| E′0 | MPa | 8.16 | 6.01 | 9.17 | 11.76 | 12.88 | 10.90 | 7.24 | 8.84 | n.a |
| E′∞ | MPa | 6.18 | 5.42 | 6.90 | 8.15 | 8.60 | 7.41 | 5.99 | 6.53 | n.a |
| ΔE′ | MPa | 1.98 | 0.59 | 2.27 | 3.62 | 4.28 | 3.49 | 1.25 | 2.31 | n.a. |
| Tan δmax | / | 0.157 | 0.133 | 0.197 | 0.211 | 0.217 | 0.200 | 0.166 | 0.158 | n.a. |

The physical properties data is summarised in Table 5, and shows:
Elastomer compounds comprising the PCP-A filler had lower density compared to the reference fillers.
Although hardness and M100% modulus values were similar, the PCP-A filler had improved M300%, tensile strength and elongation at break values compared to the commercial CCRF. PCP-B filler also improved M100%, as well as M300%, tensile strength and elongation at break values compared to the commercial CCRF. This may be attributable to the unexpectedly superior dispersion properties of the PCP fillers in the polymer.
The rCB and N660 were more reinforcing than the CCRF and PCP fillers.
Generally, increasing the loading of the PCP filler resulted in increases in stiffness and reductions in ultimate tensile properties.
Blending the PCP-A filler with N660 resulted in physical properties broadly between the two.
Blending the PCP-A and CCRFs resulted in an M300% modulus between the two but with enhanced ultimate tensile properties, suggesting that PCP can be used as an additive to improve elastomer blends that use conventional virgin CCRF.

Dynamic mechanical properties data summarised in Table 4 shows networking efficiency ΔE′(E′0-E′∞): This parameter offers a measure of filler-filler interactions and confirms that the PCP filler exhibits a greater level of filler networking compared to the reference fillers. As would be expected, the filler-filler interactions increase with increasing loadings of the PCP filler. The PCP-A/N660 blend compound had a higher ΔE′ value compared to the individual PCP-A and N660 compounds; although, the total filler loading was increased by 5 phr for the blend.

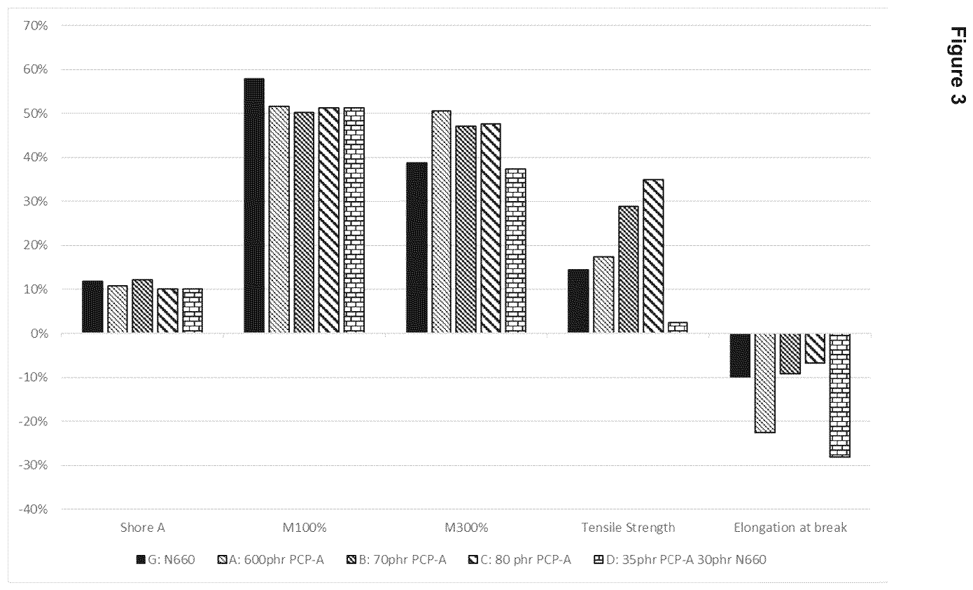

After ageing in air at 70° C. for 7 days formulations A-D and G can be seen to have stiffened, as indicated by increases in hardness, modulus values, Table 5. FIG. 3 shows the percentage differences between hot air aged materials compared with their unaged, equivalent, M100 increases from ageing for PCP-A formulations (A-D) were slightly lower in magnitude to those for N660 (formulation G), whereas M300 was slightly higher than N660 for formulations A-C but the same for formulation D. Tensile strength values though did change after ageing for PCP-A formulations A-C, but were much lower for formulation D, which was much improved versus N660 alone. Reductions in elongation at break were similar in magnitude to that of N660 for formulations B and C, but higher for formulations A and D. In summary, except for tensile strength, the ageing properties of SBR blends containing PCP-A alone (formulations A-C) were broadly similar to N660. Formulation D containing both N660 and PCP-A performed best for tensile strength after ageing.

Differences in ageing performance may reflect different ageing mechanisms. Some ageing causes stiffening due to increases in crosslink density whereas some ageing causes softening due to chain rupture.

### Conclusions:

The PCP-A filler displays significantly different in-rubber behaviour when compared to a commercial filler made from virgin coal. The main differences being:
Superior dispersion. This is an important consideration, especially for rubber articles operating in a dynamic environment or requiring a clean surface finish.
Significantly improved higher strain modulus and ultimate tensile properties.
Significantly increased filler networking and associated energy losses.

### Example 4—Influences of Elastomer Composite Filler Loading for Natural Rubber Blends Using the PCP-A in Comparison to N772

In this example, the PCP material is shown to disperse efficiently and provides surprisingly good reinforcing potential for a natural rubber, comparable to albeit less than carbon black grade, N772, when tested at equal loadings. The formulation, containing PCP-A or SRF N772 and BS1154 Z60 Gum masterbatch was mixed on the polylab internal mixer with Banbury rotors. The mix was then rolled on a 2-roll mill and the resultant sheets were taken to a hot press for curing. Tensile bars were pressed out of these sheets and tested using the ISO 37—Type 1 and Shore A hardness methods. Tensile testing was carried out using a 5 kN load cell at a speed of 100 mm·minute and shore hardness readings were taken 30 seconds after penetration.

Results detailed in Table 6 show that the tensile strength of natural rubber increases proportionally to the concentration of PCP-A, such that a 20% blend has increased tensile strength by ˜75% and modulus @ 300% by 39%. A 10% blend of PCP-A increases the Shore hardness by almost 2 units and increases extension % by 13%.

TABLE 6
Physical properties of NR compounds blended with PCP-A and N772

| | | Tensile | | | | |
|---|---|---|---|---|---|---|
| Average | Max | Strength, | Extension, | Modulus @ | Modulus @ | Shore A |
| Data | Force, N | N/mm² | % | 100% | 300% | Hardness |
| Natural Rubber | 77.33 | 4.20 | 707.67 | 13.67 | 30.02 | 40.5 |
| 5% PCP-A | 88.38 | 5.01 | 742.81 | 13.56 | 30.43 | 40.67 |
| 5% CB N772 | 102.88 | 5.97 | 799.95 | 14.78 | 31.98 | 41.67 |
| 10% PCP-A | 115.68 | 6.15 | 800.03 | 14.70 | 34.36 | 42.33 |
| 10% CB N772 | 122.44 | 7.30 | 799.97 | 15.07 | 35.27 | 42.17 |
| 20% PCP-A | 149.68 | 7.30 | 800.00 | 16.74 | 41.74 | N/A |
| 20% CB N772 | 162.43 | 9.23 | 800.03 | 17.10 | 43.38 | N/A |

### Example 5.—Matching Properties of Specific NR/NBR and EPDM-Carbon Black Elastomeric Blends by Replacement of a Proportion of Carbon Black by PCP-B

The samples were prepared (Table 7) and tested (Table 8) as for example 3, excepting that the Moving Die Rheometer testing was conducted at 193° C. for 6 min for the Natural Rubber and EPDM formulations J-L, P-R, and at 177° C. for 20 min for the Acrylonitrile (NBR) formulations M-O. Formulations K, L, N, O, Q and R were chosen to best match the performance of the reference carbon black blends J, M and P.

TABLE 7
Formulation details for NR, NBR and EPDM compounds blended with PCP-B

| | | |
|---|---|---|
| Natural Rubber | NBR | EPDM |

Concentration in parts per hundred rubber (phr)

| Ingredient | J | K | L | M | N | O | P | Q | R |
|---|---|---|---|---|---|---|---|---|---|
| NR CV60 | 100 | 100 | 100 | — | — | — | — | — | — |
| NBR | — | — | — | 100 | 100 | 100 | — | — | — |
| EPDM | — | — | — | — | — | — | 100 | 100 | 100 |
| PCP-B Filler | — | 12 | 12 | — | 12 | 12 | — | 26 | 26 |
| N550 | 40 | 32 | 32 | 30 | 30 | 30 | — | — | — |
| N650 | — | — | — | — | — | — | 160 | 136 | 148 |
| N762 | — | — | — | 70 | 56 | 63 | — | — | — |
| Zinc Oxide | 4 | 4 | 4 | 5 | 5 | 5 | 5 | 5 | 5 |
| Stearic acid | 2 | 2 | 2 | 1 | 1 | 1 | 1 | 1 | 1 |
| 6PPD | 1 | 1 | 1 | — | — | — | — | — | — |
| TMQ | 1 | 1 | 1 | — | — | — | — | — | — |
| PEG4000 | — | 0.1 | 0.4 | — | — | — | 2.5 | 2.5 | 2.5 |
| TBBS | 1.5 | 1.5 | 1.5 | — | — | — | — | — | — |
| Mesamoll | — | — | — | 10 | 10 | 10 | — | — | — |
| MBTS | — | — | — | 1.5 | 1.5 | 1.5 | — | — | — |
| Paraffinic oil | — | — | — | — | — | — | 105 | 105 | 105 |
| CaCO₃ | — | — | — | — | — | — | 80 | 80 | 80 |
| Cure package | — | — | — | — | — | — | 5.1 | 5.1 | 5.1 |
| Sulphur | 1.5 | 1.5 | 1.5 | 1.5 | 1.5 | 1.5 | — | — | — |

Natural Rubber (NR): The curing characteristics of NR formulation K very closely resemble those of the reference formulation J. Of the mechanical properties, M100 and elongation at break were equivalent, but M300 and tensile strength slightly lower. Better M300 and tensile strength values obtained from a confirmatory test with formulation L. Shore Hardness was unaffected. This demonstrates that PCP-B can be used at certain proportions as a substitute for carbon black with almost matching properties.

TABLE 8
Cure characteristics and physical properties of NR, NBR and EPDM compounds blended with PCP-B

| | | Natural Rubber | | | NBR | | | EPDM | | |
|---|---|---|---|---|---|---|---|---|---|---|
| Test | Unit | J | K | L | M | N | O | P | Q | R |
| Min torque | dNm | 1.11 | 1.21 | — | 2.66 | 2.38 | 2.80 | 3.15 | 2.74 | 3.19 |
| Max torque | dNm | 13.8 | 13.4 | — | 22.1 | 19.3 | 20.8 | 21.5 | 16.4 | 17.4 |
| Ts2 | min | 0.42 | 0.43 | — | 0.94 | 1.00 | 0.98 | 0.27 | 0.28 | 0.28 |
| T90 | min | 0.74 | 0.73 | — | 2.54 | 2.55 | 2.65 | 4.04 | 4.39 | 4.26 |
| Shore A | ° | 57 | 56 | 56 | 75 | 73 | 75 | 72 | 68 | 72 |
| ASTM D2240 | | | | | | | | | | |
| M100% | MPa | 2.0 | 2.1 | 2.2 | 5.1 | 5.0 | 5.6 | 5.1 | 4.0 | 4.8 |
| M300% | MPa | 10.9 | 9.3 | 9.8 | 17.1 | 14.8 | 15.5 | * | 9.8 | 10.7 |
| Tensile | MPa | 25.9 | 22.2 | 23.8 | 18.6 | 15.4 | 15.6 | 13.1 | 11.6 | 10.8 |
| Strength | | | | | | | | | | |
| Elongation | % | 539 | 542 | 531 | 340 | 327 | 304 | 269 | 363 | 303 |
| at break | | | | | | | | | | |

Did not achieve 300% extension therefore there is no M300 value

Acrylonitrile rubber (NBR). The cure characteristics of NBR formulations N and O closely resemble those of the reference formulation M and no PEG accelerant was required. Of the mechanical properties, M100 was equivalent, whereas M300, tensile strength and elongation at break were 10-15% lower. Shore Hardness was unaffected. Nevertheless, the properties of N and O are a strong match for the reference M. Tensile strength can be altered by varying the ratio of PCP-B and carbon black N762.

Ethylene propylene diene monomer rubber (EPDM). The cure characteristics of EPDM formulations Q and R are similar to those of the reference formulation P. Additional PEG may lift the torque values of Q and R to those of P. Of the mechanical properties, elongation at break was improved, whereas tensile strength and M100 were lower. Shore Hardness was again relatively unaffected. Nevertheless, the properties of Q and R remain a strong match for most properties of the reference P. Tensile strength can be altered by varying the ratio of PCP-B and carbon black N762.

### Example 6. Influences of Elastomer Composite Filler Loading for Bromobutyl Rubber Blends Using the PCP-A in Comparison to Either N660 and a Commercial CCRF

Samples were prepared using a generic model bromobutyl (BIIR) based tyre inner-liner formulations (Table 9) and tested (Table 10) as in Example 3 excepting that the Moving Die Rheometer testing was conducted at 170° C. for 60 min following the mixing procedure given in Table 4.

Nitrogen permeation resistance was measured: 0.5 mm thick discs of each compound were prepared for gas permeation testing. Testing followed ASTM D1434-82 (09) e1 using a LabThink VAC-V1gas permeability tester. The nitrogen transmission rate was determined at 23° C. for a sample test area of 38.48 cm².

TABLE 9
Formulation details for Bromobutyl (BIIR)
based tyre inner-liner compounds

| | | | | | | |
|---|---|---|---|---|---|---|
| Ingredient | S | T | U | V | W | X |

Concentration in parts per hundred rubber (phr)

| | | | | | | |
|---|---|---|---|---|---|---|
| Bromobutyl X2 | 100 | 100 | 100 | 100 | 100 | 100 |
| PCP-A Filler | — | 10 | 20 | 30 | 10 | — |
| CCRF | — | — | — | — | 10 | 20 |
| N660 | 60 | 50 | 40 | 30 | 40 | 40 |
| Naphthenic oil | 10 | 10 | 10 | 10 | 10 | 10 |
| Magnesium oxide | 0.3 | 0.3 | 0.3 | 0.3 | 0.3 | 0.3 |
| Zinc Oxide | 3 | 3 | 3 | 3 | 3 | 3 |
| Stearic acid | 2 | 2 | 2 | 2 | 2 | 2 |
| Norsolene S95 | 4 | 4 | 4 | 4 | 4 | 4 |
| PEG4000 | — | −0.33 | −0.67 | −1 | −0.33 | — |
| MBTS | 1.5 | 1.5 | 1.5 | 1.5 | 1.5 | 1.5 |
| Sulphur | 0.5 | 0.5 | 0.5 | 0.5 | 0.5 | 0.5 |

The physical properties data in Table 11 show that replacing N660 with the PCP-A leads to:
Lower nitrogen gas transmission rates (GTR), reducing progressively as PCP-A loading is increased from 10. At 50% replacement of N660 with PCP-A, the GTR is reduced by 25%.
Increased modulus values (M100% and M300%) which are not observed with blends W and X containing CCRF.
Average surface roughness (Ra) approaching close to that of N660 as the loading of PCP-A increases, i.e. 0.36 microns for formulation V compared with 0.33 for S. Blends containing CCRF have higher surface roughness, e.g. Ra for formulations U and X which contain 20 phr of PCP-A and CCRF are 0.38 microns and 0.42 microns resp[ectively.
Slightly reduced hardness.
Reduced tensile strength; however, this only becomes apparent at 50% replacement.
Reduced elongation at break, likely attributable to the slightly poorer dispersion of PCP-A.

TABLE 10
Physical properties (including hot air aged) of bromobutyl
(BIIR) based tyre inner-liner formulations

| Test | Unit | S | T | U | V | W | X |
|---|---|---|---|---|---|---|---|
| Min torque | dNm | 1.93 | 2.09 | 2.16 | 2.23 | 2.28 | 1.81 |
| Max torque | dNm | 6.72 | 7.40 | 7.87 | 7.97 | 7.62 | 6.42 |
| Ts2 | min | 2.68 | 3.74 | 3.39 | 3.37 | 3.95 | 4.31 |
| T90 | min | 7.17 | 14.02 | 15.43 | 16.75 | 13.84 | 10.68 |
| Shore A | ° | 53 | 49 | 48 | 48 | 46 | 46 |
| ASTM D2240 | | | | | | | |
| M100% | MPa | 1.27 | 1.33 | 1.40 | 1.44 | 1.26 | 1.08 |
| M300% | MPa | 4.72 | 6.02 | 6.23 | 5.84 | 4.86 | 3.43 |
| Tensile | MPa | 10.9 | 10.9 | 10.5 | 9.2 | 9.7 | 9.4 |
| Strength | | | | | | | |
| Elongation | % | 716 | 581 | 576 | 536 | 595 | 732 |
| at break | | | | | | | |
| Ra (Average | microns | 0.33 | 0.42 | 0.38 | 0.36 | 0.44 | 0.42 |
| surface | | | | | | | |
| roughness) | | | | | | | |
| Density | g/cm³ | 1.144 | 1.132 | 1.115 | 1.101 | 1.116 | 1.216 |
| Nitrogen GTR | cm³/m² · | 33.85 | 29.01 | 27.89 | 25.53 | 28.26 | 27.95 |
| | 24 h · 0.1 MP | | | | | | |

HOT AIR AGED PROPERTIES

| Shore A | ° | 55 | 51 | 50 | 49 | n.a. |
|---|---|---|---|---|---|---|
| ASTM D2240 | | | | | | |
| M100% | MPa | 1.52 | 1.46 | 1.53 | 1.54 | |
| M300% | MPa | 5.48 | 6.37 | 6.88 | 6.22 | |
| Tensile | MPa | 11.0 | 11.1 | 10.4 | 9.6 | |
| Strength | | | | | | |
| Elongation | % | 699 | 563 | 509 | 486 | |
| at break | | | | | | |

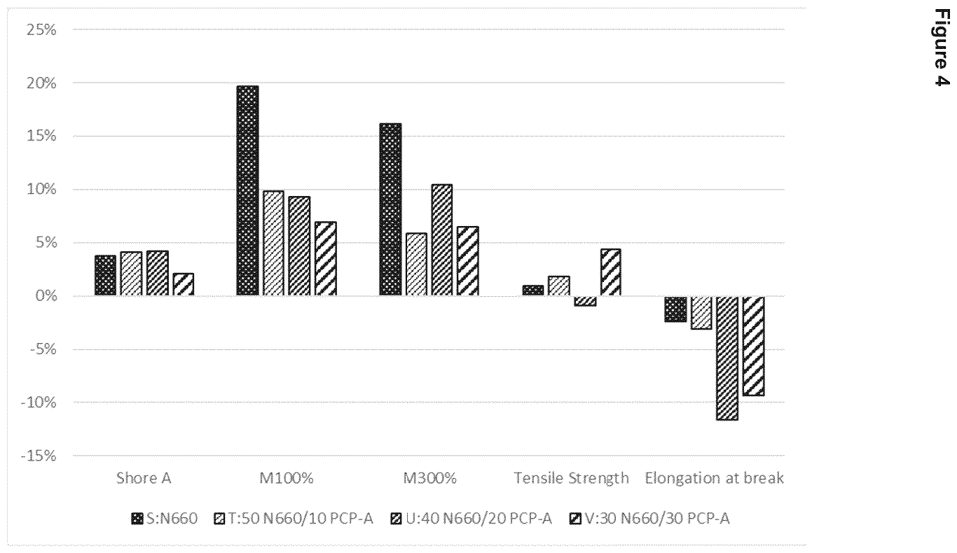

After ageing in air at 70° C. for 7 days all seven formulations (S-X) can be seen to have stiffened, as indicated by increases in hardness and modulus values, Table 10. FIG. 4 shows the percentage differences between hot air aged materials compared with their unaged equivalent, Stiffness increases from ageing were more pronounced for N660 (formulation S) with PCP-A blends (formulations T-V) having greater resistance to hot air ageing for Shore hardness, M100 and M300. Tensile strength values did not change substantially after ageing for PCP-A formulations T and U compared with S (N660), however at 30 phr PCP-A (formulation V) there was a larger change in tensile strength, albeit less than 5%. Reductions in elongation at break were also slightly higher at the higher loadings of PCP-A (formulations U and V). In summary except for elongation at break. the resistance to ageing of bromobutyl blends containing PCP-A (formulations T-V) were either better than N660 alone (M100 and M300), or similar to N660 (Shore hardness and Tensile Strength).

The results show that PCP-A can be used at higher loadings and demonstrate comparable in-elastomer properties to that of a commercial carbon black. Given that PCP-A can be manufactured from waste materials, such as tailings from mining operations, this provides a readily available supply of material that would otherwise be discarded. The results in Table 6 show that an elastomer comprising 20% PCP-A derived from waste material exhibited properties that were highly comparable to elastomer comprising 10% N772 carbon black.

Although particular embodiments of the invention have been disclosed herein in detail, this has been done by way of example and for the purposes of illustration only. The aforementioned embodiments are not intended to be limiting with respect to the scope of the appended claims, which follow. It is contemplated by the inventors that various substitutions, alterations, and modifications may be made to the invention without departing from the spirit and scope of the invention as defined by the claims.

1. An elastomeric composite composition comprising:
at least one polymer component; and
a purified carbonaceous product (PCP) composition, wherein:
the PCP is in particulate form and is obtained from a native coal,
the native coal is comprised of a coal waste material,
the coal waste material comprises coal ultrafines and/or coal microfines, and
at least about 90% by volume (% v) of the particles are no greater than about 25 μm in diameter; have an ash content of less than about 5 wt % and a water content of less than around 2 wt %.

2. The elastomeric composite composition of claim 1, wherein at least about 95% v of the PCP particles are no greater than about 25 μm in diameter.

3. The elastomeric composite composition of claim 1, wherein the average particle size of the PCP is no more than 10 μm.

4. The elastomeric composite composition of claim 3, wherein the at least about 95% v of the PCP particles have an average particle size of the PCP that is not more than 10 μm.

5. The elastomeric composite composition of claim 3, wherein the at least about 99% v of the PCP particles have an average particle size of the PCP that is not more than 10 μm.

6. The elastomeric composite composition of claim 1, wherein the average particle size of the PCP is determined by laser diffraction.

7. The elastomeric composite composition of claim 1, wherein the PCP is comprised of particles having a substantially planar morphology.

8. The elastomeric composite composition of claim 1, wherein the PCP has an ash content of less than about 4 wt %, suitably less than 3 wt % and typically less than about 2 wt %.

9. The elastomeric composite composition of claim 1, wherein the PCP has a water content of less than about 1.5 wt % typically less than about 1 wt %.

10. The elastomeric composite composition of claim 1, wherein the polymer comprises: homo-polymers or co-polymers of 1,3 butadiene; styrene; isoprene; isobutylene; 2,3-dimethyl-1,3-butadiene; acrylonitrile; ethylene; propylene; acrylonitrile butadiene rubber (NBR); ethylene propylene diene monomer rubber (EPDM); styrene-butadiene rubber (SBR); bromobutyl rubber (BIIR); natural rubber (NR); halogenated rubbers; silicone; phosphazene; thionylphosphazene; fluoropolymers; polyolefins; polyesters; nylon; polyamides; polybutadiene; polyisoprene; and their oil-extended derivatives and/or blends thereof.

11. The elastomeric composite composition of claim 1, wherein the elastomeric composite composition further comprises a filler selected from a carbon black or recovered carbon black (rCB).

12-13. (canceled)

14. The elastomeric composite, of claim 1, wherein the native coal is comprised of one or more of the group consisting of: hard coal, such as anthracite; bituminous coal; sub-bituminous coal; and brown coal, including lignite (as defined in ISO 11760:2005).

15. The elastomeric composite, of claim 1, wherein the composite further comprises an organic filler, wherein the organic filler comprises cellulose.

16. (canceled)

17. The elastomeric composite composition of claim 15, wherein the composite further comprises an inorganic filler, wherein the inorganic filler comprises silica or calcium carbonate.

18. The elastomeric composite composition of claim 1, wherein the composition further comprises at least one or more components selected from: plasticizers, tackifying agents, curing agents, pigments, void or pore forming agents, reinforcing fillers, stabilizers, bulking agents, processing aids, or antioxidants.

19. The elastomeric composite composition of claim 1, wherein the composition comprises at least 5 parts by weight of PCP with respect to 100 parts by weight of the polymer component (parts per hundred).

20. The elastomeric composite composition of claim 1, wherein the composition comprises up to at most 100 parts by weight of PCP with respect to 100 parts by weight of the polymer component (parts per hundred).

21. An article of manufacture that comprises an elastomeric composite composition as defined in claim 1.

22. The article of manufacture of claim 21, wherein the article is selected from: a vehicle tyre (including tyre linings, beads, tread or sub-tread components and inner tubes); a seal; a gasket; a drive belt; a conveyor belt; a rubber mat; a hose; flooring; a dampener; a shock absorber; a membrane; a rubberised coating; an elastomeric polymer textile; an elastic cord or band; personal protective equipment (PPE); a medical device; or sporting equipment and apparel.

23-41. (canceled)
